(19) United States
(12) Patent Application Publication
(10) Pub. No.: US 2002/0175305 A1
(43) Pub. Date: Nov. 28, 2002

(54) Multiblade damper with DC actuator and double knee lock blade operator

(76) Inventors: Francis J. McCabe, Ottville, PA (US); Paul B. Keenan, Quakertown, PA (US)

Correspondence Address: BENASUTTI, P.A., 17294 BERMUDA VILLAGE DRIVE, BOCA RATON, FL, 33487, US

(21) Appl. No.: 10/154,361

(22) Filed: May 24, 2002

Related U.S. Application Data
(60) Provisional application No. 60/293,678, filed on May 25, 2001.
(60) Provisional application No. 60/293,639, filed on May 25, 2001.
(60) Provisional application No. 60/293,656, filed on May 25, 2001.

(51) Int. Cl. F16K 31/02; F24F 13/14

(52) U.S. Cl. 251/129.12; 454/335

(57) ABSTRACT

A damper has a plurality of blades movable between an open and a closed position in response to an operating/actuating means attached to the blades. A shaft rotatable about its axis has lever arm means attached to it and to said blades, to open and close said damper in response to rotation of said shaft for 180 degrees of travel. Connector arm means are pivotally connected to crank arms and pivotally connected to said blades at pivot point locations such that the pivot points of said pivotal connections are over center of the plane of the axis of said shaft when the blades are in the open and closed positions.

Limit switches are provided to automatically stop the travel of the blades at fully open and fully closed positions.

### CROSS-REFERENCE TO RELATED APPLICATIONS

This application is a Continuation-in-Part of our prior provisional applications, namely MULTIBLADE DAMPER WITH DC ACTUATOR AND DOUBLE KNEE LOCK BLADE OPERATOR, Ser. No. 60/293,678, filed May 25, 2001; MULTIBLADE MODULATING DAMPER WITH A CHAIN DRIVE, Ser. No. 60/293,639, filed May 25, 2001; CHAIN OPERATOR DRIVE FOR A BUTTERFLY DAMPER WITH DOUBLE ACTING OVER CENTER LOCK, Ser. No. 60/293,656, May 25, 2001; and utility application for DRIVE FOR BUTTERFLY DAMPER WITH DOUBLE ACTING OVER CENTER LOCK, Ser. No. 10/015312, filed Dec. 11, 2001; the disclosures of all of which are incorporated herein by reference as if fully set forth.

### BACKGROUND OF THE INVENTION

1. Technical Field

This invention relates to air/fire/smoke multiblade dampers and, in particular, to a mechanism for operating said dampers and maintaining those dampers in a fully opened, partially opened, and fully closed position.

2. Background Art

In the prior art, a variety of means are known for operating dampers to move the blades from a closed to an open position and to return them to the closed position. When electric motors were used to open the dampers and close them, the motors typically had only 90 degrees of rotation.

### DISCLOSURE OF THE INVENTION

### SUMMARY OF THE INVENTION

This invention provides actuators/operators for air, smoke and fire control dampers with 180 degree drive shaft arm rotation from over center held locked open to over center held locked closed. The apparatus automatically stops in either direction, can reverse, or can continue in the same direction.

In one embodiment, a switch means may be provided to cut the power to the motor driving the damper actuator; and in that event, the damper will be maintained in its partially opened position.

In accordance with the preferred and/or alternate embodiments of our invention it comprises a damper having at least one blade movable between a first position in which the damper is closed by said blade and a second position in which the damper is opened by said blade, upon movement of an operating/actuating means attached to said blade, wherein there is an improvement comprising:

said operating/actuating means further comprising a direct current motor connected to a power source for supplying electricity to operate said motor and move said blade; and

control means connected to said motor and said power source to control the flow of electricity there between, comprising limit switch means for interrupting the flow of electricity to the motor to stop it and thereby stop the movement of the blade in at least one of said positions.

The limit switch means further comprises at least one or a plurality of micro switches.

The operating/actuating means further comprises engagement means for engaging at least one micro switch to operate said switch upon certain movement of said engagement means, and thereby interrupt the flow of electricity to said motor as aforesaid; or the operating/actuating means further comprises engagement means for selectively engaging one and another of said plurality of micro switches to operate said switches upon certain movements of said engagement means, and thereby interrupt the flow of electricity to said motor as aforesaid.

The operator/actuator means further comprises lever means comprising a plurality of levers pivotally connected to one another; and the engagement means further comprises a striker means attached to one of said levers for engaging at least one micro switch to operate said switch upon certain movement of said engagement means, and thereby interrupt the flow of electricity to said motor as aforesaid; or the operating/actuating means further comprises lever means comprising a plurality of levers pivotally connected to one another; and the engagement means further comprises a striker means for selectively engaging one and another of said plurality of micro switches to operate said switches upon certain movements of said engagement means, and thereby interrupt the flow of electricity to said motor as aforesaid.

The motor has a shaft which can rotate at least 180 degrees when the motor is operated; and said shaft is connected to said lever means to move said lever means in response to movement of said motor shaft.

The motor has a shaft which can rotate at least 180 degrees when the motor is operated; and said shaft is connected to said lever means to move said lever means in response to movement of said motor shaft.

In operation, the motor is reversed by a change in the direction of the flow of electrical current thereto, thereby reversing the direction of rotation of the motor shaft and reversing the movement of said lever means.

The control means further comprises additional power interrupt means to cutoff the flow of electricity to said motor and thereby stop said motor and further, to thereby stop said blade in any of said positions and between said positions.

The operator/actuator means further comprises lever means comprising a plurality of levers pivotally connected to one another and arranged to provide an over center lock to prevent reverse movement of said operating means when the flow of electricity to said motor is cut off and said blade is stopped in any of said positions.

The operator/actuator means further comprises additional mechanical means to prevent reverse movement of said operating means when the flow of electricity to said motor is cut off and said blade is stopped in any of said positions, and between said positions.

The control means further comprises micro switches having at least three terminals, consisting of a neutral terminal, a normally open terminal and a normally closed terminal; and a diode means comprising a diode is connected between the normally open and normally closed terminals to control the flow of current there between.

The motor has at least two terminals; and the power source has at least two terminals; and the control means further comprises: electrical circuitry means comprising an electrical connector between one terminal of the power source and the neutral terminal of one micro switch; an electrical connector between one terminal on the motor and one terminal on one micro switch; and an electrical connector between another terminal of the power source and the neutral terminal of another micro switch; and an electrical connector between another terminal on the motor and one terminal on another micro switch.

### BRIEF DESCRIPTION OF DRAWINGS

FIG. 1 is a perspective view taken from the right front side of a damper with the blades shown in a closed position;

FIG. 2 is a perspective view taken from the right front side of a damper with the blades shown in the opened position;

FIG. 3 is a right side elevation of a damper as shown in FIG. 1;

FIG. 4 is an enlarged view of a portion of the damper shown in FIG. 3 with electric parts show schematically;

FIG. 5 is an enlarged top view of a portion of the damper as shown in FIGS. 1 through 4;

FIG. 6 is an electrical schematic of a portion of the apparatus, as shown in the prior Figures with alternate positions shown in phantom lines;

FIG. 7 is a side elevation of a damper in accordance with our invention as shown in the partially opened condition;

FIG. 8 is a right side elevation of an apparatus in accordance with an alternate embodiment of our invention; and

FIG. 9 is a schematic representation of a portion of the apparatus shown in FIG. 8.

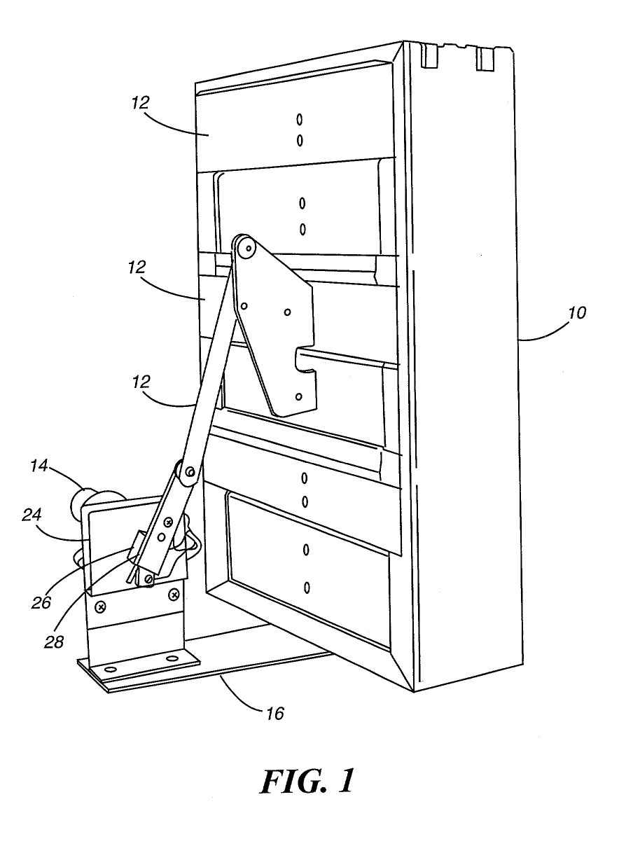

### DESCRIPTION OF THE PREFERRED EMBODIMENTS

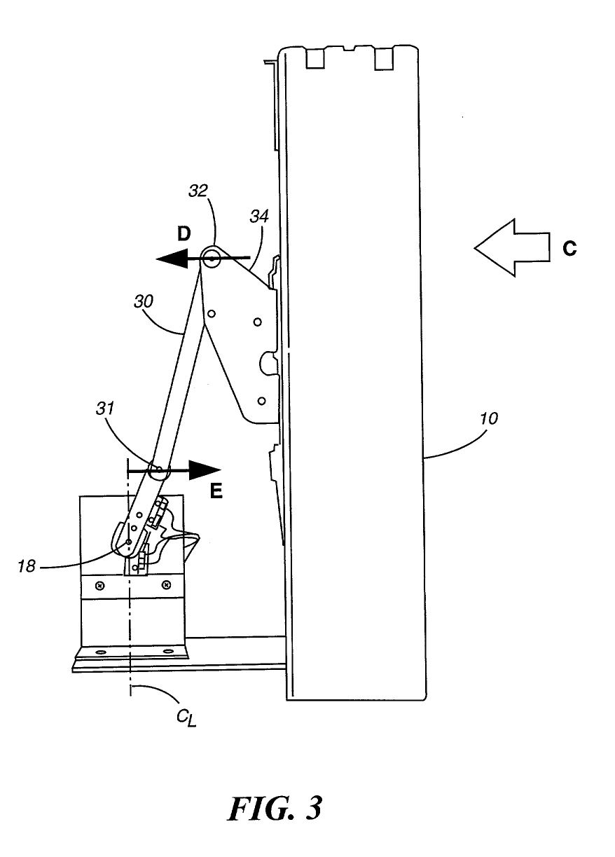

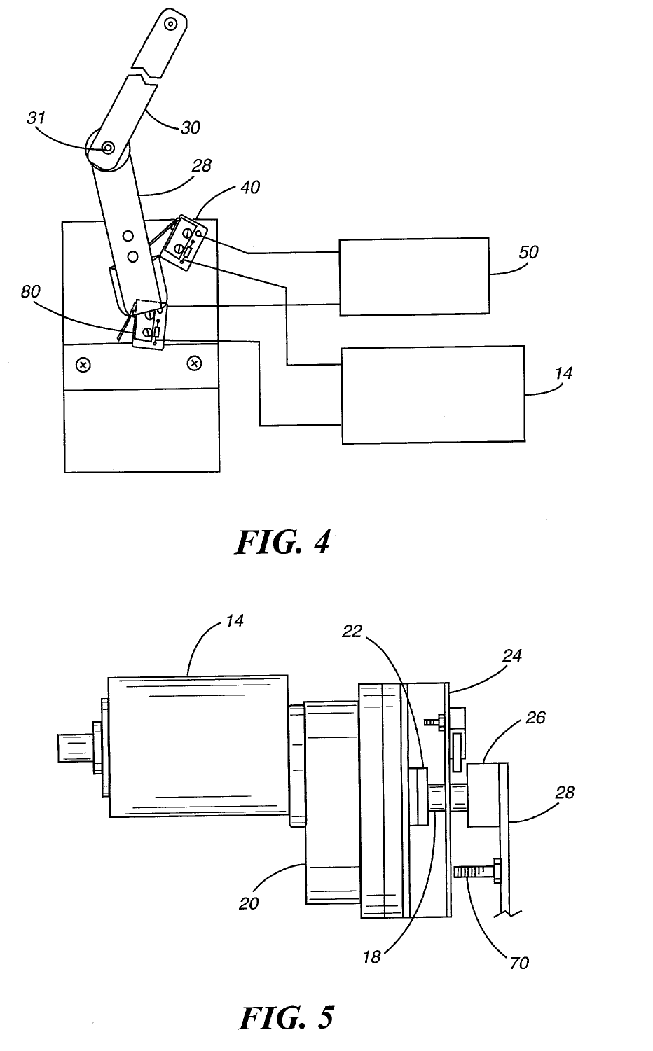

In accordance with our invention, the damper comprises a frame 10, having a plurality of blades 12 pivotally mounted therein for rotation between opened and closed positions. The actuator operating means comprises a motor 14 mounted to an extension 16 connected to the frame 10. The motor operates a shaft 18, FIG. 5, through a gear box 20. The shaft extends from the hub 22 through the mounting plate 24. A lever means is provided comprising a block 26 fixedly mounted to the end of the shaft and having fixedly mounted thereto one end, a lever arm 28 for rotation with the shaft. The other end of the lever arm 28 is pivotally connected to a further actuating arm 30 at 31, FIG. 4. The other end of the lever arm 30 is pivotally connected to a blade bracket 34 at 32, FIG. 3. Blade brackets 35 are connected to each blade and are interconnected for movement together by means of a link bar (not shown on the other side, in FIG. 3, but known in the art).

By this arrangement, when the motor rotates the shaft 18, the lever arms, link bars and bracket function to open and close the damper blades, as will be both fully described hereinafter.

In the prior art, motors which were used for operating dampers typically had a travel of 90 degrees. In accordance with our invention, the motor has a travel of 180 degrees. This 180 degree travel allows us to use a smaller motor and it gives us more power for the same size damper.

The motor is preferably a DC, that is direct current, motor and is connected to a circuit which permits reversing the polarity of the current to the motor. Reversing the polarity means that the motor can rotate either clockwise and counterclockwise depending on the polarity.

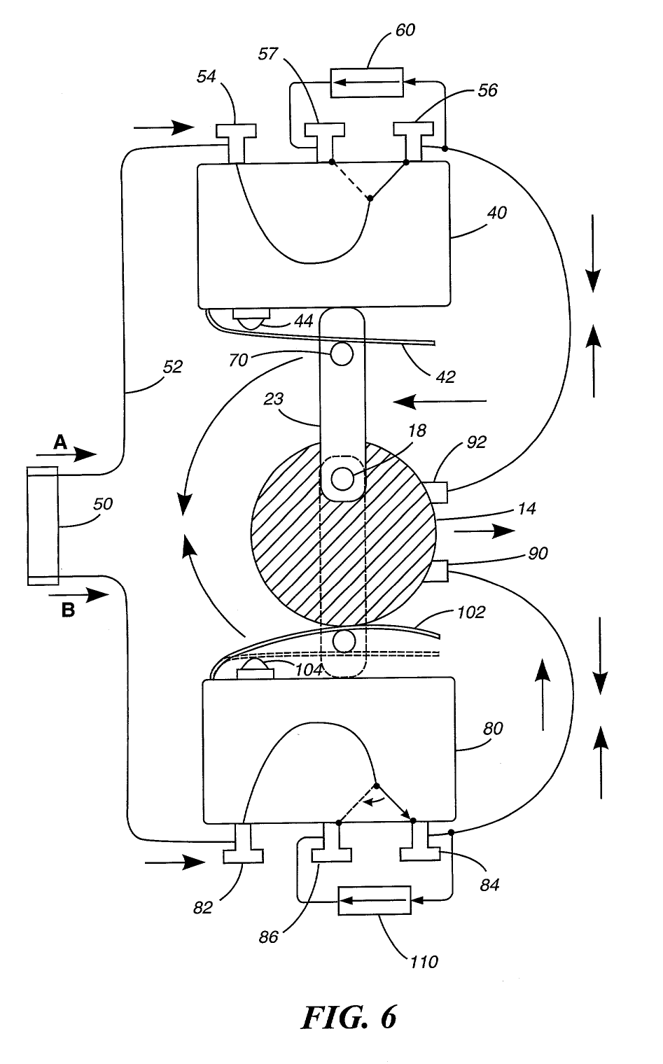

Limit switch means for accomplishing the opening and closing of the damper comprises a plurality of micro switches and circuitry between the motor and the power source for interrupting the flow of electricity to the motor. The micro switch 40, FIGS. 4 and 6, is mounted on a plate 16, as shown. Micro switch 40 is actuated by an arm 42 which is made of a flexible material and is normally biased so as to be separated from engagement with the contact 44. The micro switch is wired to the power supply 50 through wire 52 at its common terminal 54. In a damper's open mode, current passes through this whole system in a clockwise direction when viewed as in FIG. 6. Thus, direct current passes in the direction of the arrow A from the power supply to the common terminal. In this initial operating condition, the power goes through the normally closed terminal 56 of micro switch 40, to the motor 14 at contact 92; and then from the motor contact 90 through the normally closed terminal 84 of micro switch 80; and out through the common terminal 82 of micro switch 80 back to the power supply. Since current is flowing, the motor is running and will turn a maximum of 180 degrees; for example, from the position shown in phantom lines to the position shown in full lines. Engagement means for engaging the micro switch comprises a striker means carried by the lever 28. Once the striker 70 reaches the arm 42 and depresses it so that the arm 42 makes contact with the contact 44, this switches the micro switch internally from the position shown in solid lines in which it is connected to the normally closed terminal 56 to the normally open terminal 57 (as shown by the dotted lines). Since it switches to the normally open terminal 57, the current will now flow from the power source 50 through the common terminal 54 to the normal open terminal 57, and then to the diode 60. However, the diode acts as a check valve and the current cannot get through. Therefore, the motor stops in that position.

When the polarity of the power is switched, current flows in a counterclockwise direction. Thus, it flows from the power supply in the direction of the arrow B through the common terminal 82 of the micro switch 80 and out through the normally closed terminal 84 to the terminal 90 of the motor 14. It then flows out through the terminal 92 of the motor and back up through the diode 60 to the normally open terminal 57 of the limit switch 40. From there it travels internally through the common terminal 54 and back to the power source 50. Thus, the motor 14 is once again activated and rotates 180 degrees in the other direction, moving the part 28 from the full line position shown in FIG. 6 to the phantom line position. As the striker 70 moves to that phantom position, it first engages the arm 102 and then depresses that arm 102 until the arm makes contact with the contact 104 of the limit switch 80. When it makes that contact, the limit switch moves from the normally closed internal position at 84 to the normally open internal position at 86. In that position, current flow is through the normally open terminal 86 to the diode 110. However, the diode interferes with current flow and current flow cannot get through. Therefore, once again, the motor stops. Thus, the engagement means selectively engages one and another of the micro switches to operate them upon certain movements thereof.

DC current can go in either direction in a circuit by reversing the polarity. But it only goes in one direction at a time; as compared to alternating current which goes in both directions.

The diode acts as a check valve to the flow of electricity.

The condition described above occurs when the motor rotates the shaft 18 and drives the lever arm 28 to move the striker 70 into contact with the flexible arms 42 and 102 and moves the arms so that they make electrical contact with the contacts on the micro switches. Thus, the micro switches are limit switches. With this lever arm 28 in the vertically upright position, as shown in FIG. 6, the damper is fully closed by the linkage mechanism. There, the limit switch 40 intercepts 20 the power to the motor and stops it. To open the damper, a switch means, be it a computer or a manual switch (not shown), changes the polarity of the DC current from the power supply 50. That DC current now flows in the counterclockwise direction, when viewed as in FIG. 6, Arrow B.

From what has been described, it will be appreciated that by placing a diode on each limit switch between the normally opened terminal and the normally closed terminal, it is possible to control the direction of flow through the circuitry.

Current can bypass the limit switch because it goes through the diode and activates the DC motor to run in the opposite direction. This current flows for approximately two seconds. The switch is now shut and the current can flow freely through the switch.

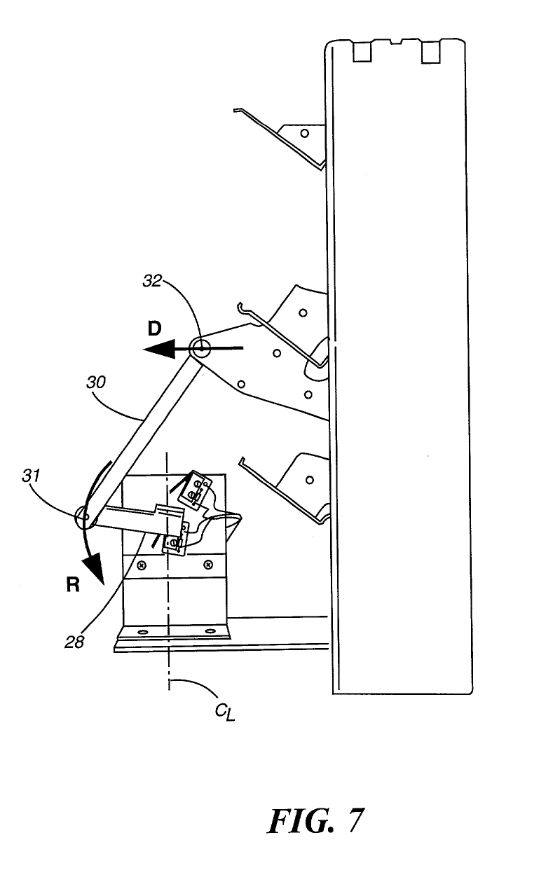

Referring to FIG. 7, it shows the damper in a partially opened position. This can be done by an additional power interrupt means comprising a switch mechanism (not shown), whether operated by computer or manually, to cut off the current from the power source 50. Thus, the damper can be stopped anywhere in between the fully opened and fully closed positions. Therefore, one can modulate the damper.

In this condition, the knee lock mechanism will not block the movement of the dampers in and of itself. However, this linkage, together with additional mechanical means comprising the motor, gears and, in the preferred embodiment, permanent magnets on the armature of the motor, will effectively prevent the damper from changing its position.

In our prior co-pending application for a MULTI-BLADE MODULATING DAMPER WITH A CHAIN DRIVE, Provisional Application No. 60/293,639, filed May 26, 2001, the disclosure of which is incorporated herein by reference, the apparatus uses a sprocket gear and chain means as part of the actuator/operator mechanism in a damper to greatly increase the power of the operating mechanism, as well as eliminate the problems inherent in the prior art actuators having multiple gears in a train.

It also provides a fully mechanically locked open and closure mechanism with no power needed to hold the damper in either position.

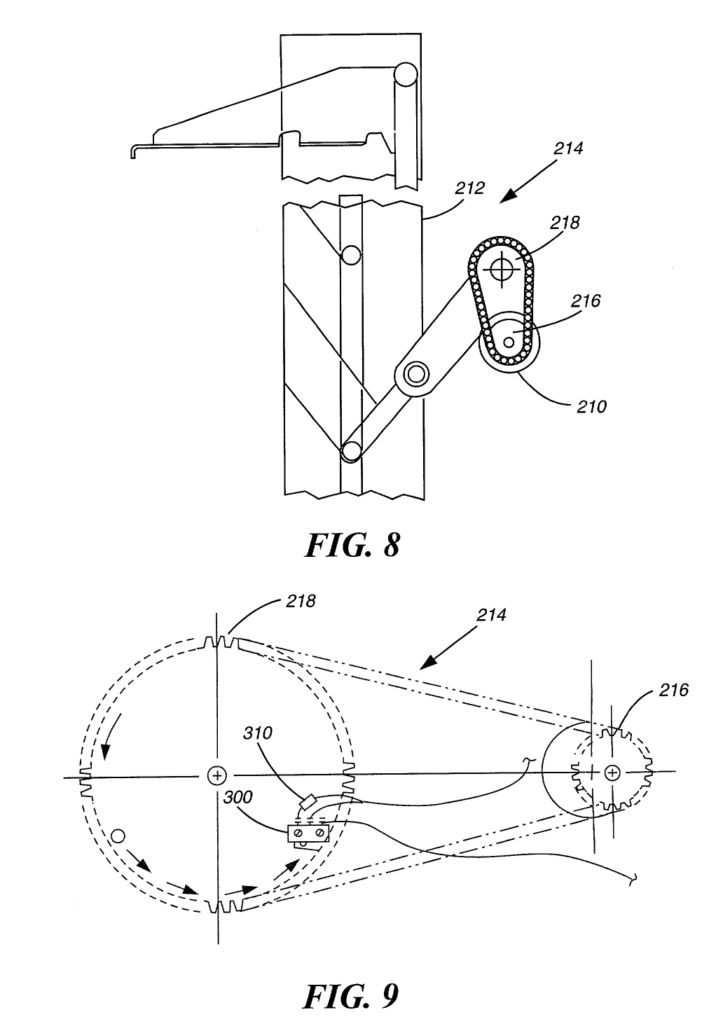

This invention uses a Pittman or REX or equivalent DC motor designated generally 210 in FIG. 8, which has a series of spur gears within it.

The device is further enhanced by use of a sprocket gear and chain drive means (designated generally 214) which comprises a sprocket 216 attached to the motor shaft to increase the gear ratio by driving a larger sprocket 218 attached to the operator shaft. In the prior art, the actuator had a gear train having five to ten gears in it; from a very small gear mounted on the motor shaft to the end gear mounted on the actuator shaft. That prior art device constantly stuck and failed. By eliminating these intermediate gears, we are able to obtain greatly enhanced power and reliable performance.

In the preferred embodiment, we are able to obtain 500-inch pounds of force for opening the damper. The gear ratio of the sprocket/chain drive is steep enough to provide enough power to open the damper 212, but not too steep to prevent back running, i.e., automatic closing of the damper under spring force. In particular, the gear ratio selected was 218 to 1 as being the most preferred.

Another advantage of this invention is that with such a powerful configuration, it is possible to drive more than one damper off the same motor.

Furthermore, because of the size of the motor, it can be placed easily within the duct, thereby protecting it in a fire situation.

Also, because it is a DC motor, it does not hum when it is fully opened in the installed condition.

In the development of this invention, it is noted that there was only a small window for operable conditions. If the gear ratio was too low, it would not open the damper and if the gear ratio was too steep, it would back run. From our experience, the gear ratio can run from a minimum of 195 to a maximum of 218.

Operation:

Referring to FIGS. 8 and 9, the power comes on to energize the motor 210. The energy comes through a limit switch 300 back to the motor to open the damper. The damper, in turn, opens until the limit switch is reached. Once the limit switch is reached, current is switched from going directly back to the motor from the limit switch to a resister 310. The resister is a 100M resister and it cuts the voltage from 21 volts down to 2 volts; which is enough to hold the damper in open position and not allow the spring return, but it is such a small amount of current that it will not break anything. When power is removed from the whole system, the mechanism springs shut to return the damper to its closed position.

A mechanism for utilizing both a chain drive and an over center linkage is disclosed in our prior co-pending application for a CHAIN OPERATOR DRIVE FOR A BUTTERFLY DAMPER WITH A DOUBLE ACTING OVER CENTER LOCK, provisional application No. 60/293,656, filed May 25, 2001, the disclosure of which is incorporated herein by reference.

As shown in FIG. 5 thereof, the device was designed such that at its uppermost and lowermost points, the cross-shaft through the sprocket gear, in both the open and the closed positions, is over center of the plane of the center line of the shaft by preferably 2/10ths of an inch.

This creates what is known as a double acting over center or knee lock. Thus, no matter how much pressure is put upon the blades, they cannot be forced open or closed.

In a fire situation where firemen would be using hoses to force water under high pressure on to the dampers, water could hit the blades of the damper and force them to open or shut. This may not be the optimal condition at the time. An advantage to this type of device is that in such a situation, the blades will not open or close in response to the force of the water.

In the present invention, the actuating means comprises an arrangement of arms such that the two pivot points go over center in both the open and closed position with 180 degrees rotation of the lever arm 28. This over center arrangement provides a knee lock in both the open and closed positions.

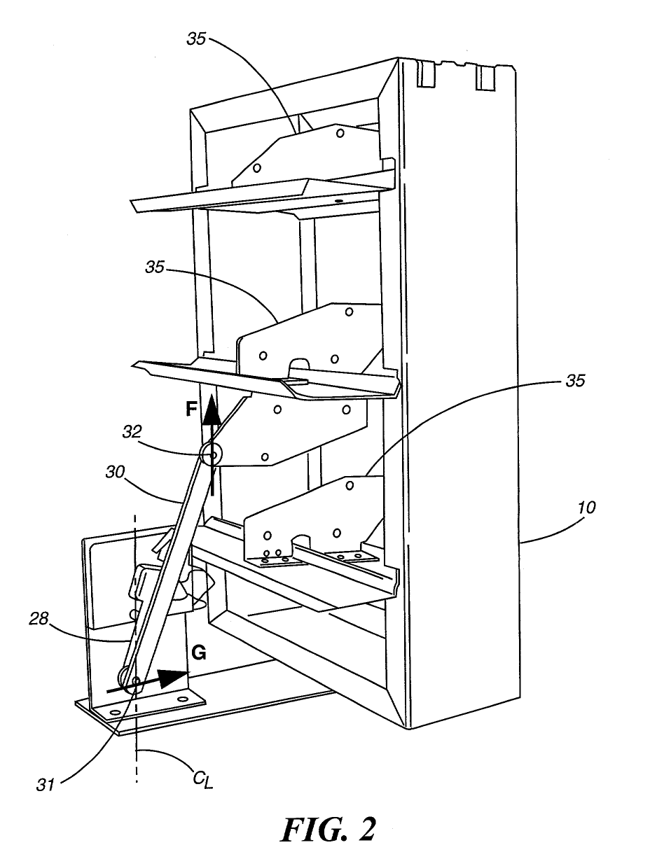

The functioning of this knee lock can be appreciated from viewing FIGS. 2, 3 and 7. Suppose, for example, there was an external force being applied to the damper from one side, as shown by the Arrow C in FIG. 3. That force would tend to be exerted on the pivot point 32 in the direction of the Arrow D. This force would then be translated through the lever 30 and attempt to force the pivot point 31 to move in the direction of the Arrow E. But that would not be possible because the motor has already run to its limit of 180 degrees of travel. The pivot point 31 is now over center of the axis of the shaft 18 (represented diagrammatically by the center line designated CL).

When the damper is partially open, as shown in FIG. 7, the pivot point 32 tends to move in the direction of the Arrow D and the arms 30 and 28 are pivoted with respect to one another about the pivot point 31, as shown by the Arrow R.

Opening continues until the fully opened position, such as shown in FIG. 2, wherein the pivot point 31 is on the other side of the center line CL.

Any force trying to exert a force to close the damper by impinging upon the damper blades, would tend to direct the pivot point 32 upwardly in the direction of the Arrow F in FIG. 2. In this condition, the pivot point 31 would tend to try to move in the direction of the Arrow G. However, it cannot do that because the motor has gone 180 degrees to its maximum position, as shown in that Figure.

1. In a damper having at least one blade movable between a first position in which the damper is closed by said blade and a second position in which the damper is opened by said blade, upon movement of an operating/actuating means attached to said blade, the improvement comprising:
said operating/actuating means further comprising a direct current motor connected to a power source for supplying electricity to operate said motor and move said blade; and
control means connected to said motor and said power source to control the flow of electricity there between, comprising limit switch means for interrupting the flow of electricity to the motor to stop it and thereby stop the movement of the blade in at least one of said positions.

2. The damper of claim 1 wherein the limit switch means further comprises at least one micro switch.

3. The damper of claim 1 wherein the limit switch means further comprises a plurality of micro switches.

4. The damper of claim 2 wherein the operating/actuating means further comprises engagement means for engaging at least one micro switch to operate said switch upon certain movement of said engagement means, and thereby interrupt the flow of electricity to said motor as aforesaid.

5. The damper of claim 3 wherein the operating/actuating means further comprises engagement means for selectively engaging one and another of said plurality of micro switches to operate said switches upon certain movements of said engagement means, and thereby interrupt the flow of electricity to said motor as aforesaid.

6. The damper of claim 4 wherein the operator/actuator means further comprises lever means comprising a plurality of levers pivotally connected to one another; and the engagement means further comprises a striker means attached to one of said levers for engaging at least one micro switch to operate said switch upon certain movement of said engagement means, and thereby interrupt the flow of electricity to said motor as aforesaid.

7. The damper of claim 5 wherein the operating/actuating means further comprises lever means comprising a plurality of levers pivotally connected to one another; and the engagement means further comprises a striker means for selectively engaging one and another of said plurality of micro switches to operate said switches upon certain movements of said engagement means, and thereby interrupt the flow of electricity to said motor as aforesaid.

8. The damper of claim 6 wherein the motor has a shaft which can rotate at least 180 degrees when the motor is operated; and said shaft is connected to said lever means to move said lever means in response to movement of said motor shaft.

9. The damper of claim 7 wherein the motor has a shaft which can rotate at least 180 degrees when the motor is operated; and said shaft is connected to said lever means to move said lever means in response to movement of said motor shaft.

10. The damper of claim 9 wherein said motor can be reversed by a change in the direction of the flow of electrical current thereto, thereby reversing the direction of rotation of the motor shaft and reversing the movement of said lever means.

11. The damper of claim 1 wherein the control means further comprises additional power interrupt means to cutoff the flow of electricity to said motor and thereby stop said motor and further, to thereby stop said blade in any of said positions and between said positions.

12. The damper of claim 1 wherein the operator/actuator means further comprises lever means comprising a plurality of levers pivotally connected to one another and arranged to provide an over center lock to prevent reverse movement of said operating means when the flow of electricity to said motor is cut off and said blade is stopped in any of said positions.

13. The damper of claim 12 wherein the operator/actuator means further comprises additional mechanical means to prevent reverse movement of said operating means when the flow of electricity to said motor is cut off and said blade is stopped in any of said positions, and between said positions.

14. The damper of claim 12 wherein the motor has a shaft rotatable about its axis; and one of said levers is attached to said shaft and another of said levers is pivotally attached to said lever and said blade at pivot point locations to open and close said damper in response to rotation of said shaft, so that the pivot points of said pivotal connections are over center of the plain of the axis of said shaft when the blades are in the closed position.

15. The damper of claim 14 wherein the pivot point connection locations are such that the pivot points of said pivotal connections are over center of the plain of the axis of said shaft when the blades are in the open position.

16. The damper of claim 5 wherein the control means further comprises micro switches having at least three terminals, said tree terminals being a neutral terminal, a normally open terminal and a normally closed terminal; and a diode means comprising a diode is connected between the normally open and normally closed terminals to control the flow of current there between.

17. The damper of claim 16 wherein the motor has at least two terminals; and the power source has at least two terminals; and the control means further comprises: electrical circuitry means comprising an electrical connector between one terminal of the power source and the neutral terminal of one micro switch; an electrical connector between one terminal on the motor and one terminal on one micro switch; and an electrical connector between another terminal of the power source and the neutral terminal of another micro switch; and an electrical connector between another terminal on the motor and one terminal on another micro switch.

18. The damper of claim 1 wherein the control means further comprises a limit switch and a resister means which comprises a micro switch and a resister wired to the micro switch and arranged such that once the limit switch is reach, current is switched from going directly back to the motor from the micro switch to a resister.

19. The damper of claim 1 wherein the operating/actuating means further comprises a sprocket gear and chain drive means which comprises a sprocket attached to said motor driving a larger sprocket for enhanced power.
